(19) United States
(12) Patent Application Publication
(10) Pub. No.: US 2022/0314581 A1
(43) Pub. Date: Oct. 6, 2022

(54) INSERT COUPLING ARTICLE OR APPARATUS

(71) Applicants: Avinash Laddha, Mumbai (IN); Dilip V. Kolhe, Silvassa (IN); William E. Hucks, Loris, SC (US)

(72) Inventors: Avinash Laddha, Mumbai (IN); Dilip V. Kolhe, Silvassa (IN); William E. Hucks, Loris, SC (US)

(21) Appl. No.: 17/842,310

(22) Filed: Jun. 16, 2022

Related U.S. Application Data
(63) Continuation-in-part of application No. 17/202,750, filed on Mar. 16, 2021.
Application No. 17/202,750 is a division of application No. 16/377,461, filed on Apr. 8, 2019, now abandoned.

(51) Int. Cl. B32B 15/085; B32B 7/12; C08L 23/06; B32B 15/20; C08K 3/04

(52) U.S. Cl. CPC B32B 15/085; B32B 7/12; C08L 23/06; B32B 15/20; C08K 3/04; C08L 2312/00; C08L 2203/18; B32B 2597/00

(57) ABSTRACT

An insert coupling apparatus or article and method of using is described, whereby the insert coupling includes a plurality of ribs and a plurality of channels formed between adjacent ribs. At least one seal ring is included. A flexible conduit or pipe is positioned on insert coupling sections with at least one crimping ring utilized to crimp the conduit/pipe by compressing the conduit/pipe material into one or more channels provided.

### RELATED APPLICATIONS

The present application is a Continuation-in-Part of application Ser. No. 17/202,750, filed on Mar. 16, 2021, the entire contents of which is incorporated herein by reference.

### FIELD OF THE INVENTION

The present invention relates to an insert coupling article, and in particular, an insert coupling article having at least one channel and seal ring for compressing a flexible conduit therein.

### BACKGROUND OF THE INVENTION

Many insert couplers have been proposed and offered, usually in combination with a crimping ring that helps secure conduit or pipe to the end of the coupler. However, there are several concerns with such insert couplers, including slippage of the crimping ring, loosening of the conduit from the coupler, or other similar failure, leading to leakage or other catastrophic failure and/or damage.

Accordingly, there is an unresolved need to provide an improved insert coupler for conduit or pipe.

### SUMMARY OF THE INVENTION

Example embodiments provide cross-linked polyethylene (PEX) composite tubing comprising an inner PEX layer and an outer polyethylene (PE) layer; an intermediate aluminum tube; and an inner adhesive layer and an outer adhesive layer, wherein the adhesive layers enveloping the intermediate aluminum tube.

Further example embodiments provide an insert coupling comprising a first coupling section comprising a tubular wall having an inner surface and an outer surface. The inner surface defines a first bore. The outer surface has a first barbed connector at the proximal terminus of the tubular wall. A plurality of axially-spaced circumferentially extending ribs each depends from the tubular wall. A first seal ring is disposed between an adjacent pair of the plurality of ribs. The insert coupling also comprises a second coupling section comprising a tubular wall having an inner surface and an outer surface. The inner surface defines a second bore. The outer surface has a second barbed connector at the proximal terminus of the tubular wall. A plurality of axially-spaced circumferentially extending ribs each depend from the tubular wall. A second seal ring is disposed between an adjacent pair of the plurality of ribs. The first bore and second bore are in mutual fluid communication.

In another embodiment, the insert coupler comprises a first coupling section comprising a tubular wall having an inner surface and an outer surface. The inner surface defines a first bore. The outer surface has a first barbed connector at the proximal terminus of the tubular wall. A plurality of axially-spaced circumferentially extending ribs are provided. A plurality of channels are formed between the plurality of ribs. A first seal ring disposed in one of the plurality channels. A first seal ring disposed in one of the channels. A second coupling section comprising a tubular wail having an inner surface and an outer surface. The inner surface defines a second bore. The outer surface having a second barbed connector at the proximal terminus of the tubular wall. A plurality of axially-spaced circumferentially extending ribs. A plurality of channels are formed between the plurality of ribs. A second seal ring disposed in one of the channels. A circumferentially extending first shoulder surface and a circumferentially extending second shoulder surface, the first shoulder surface adjacent the first coupling section and the second should surface adjacent the second coupling section

In one embodiment, the first shoulder surface and the second shoulder surface form a single circumferential shoulder intermediately disposed between the first coupling section and the second coupling section.

In another embodiment, the first shoulder surface defines a distal shoulder surface of a first shoulder circumferentially extending adjacent the first coupling section. In another embodiment, the second should surface defines a distal shoulder surface of a second shoulder circumferentially extending adjacent the second coupling section.

In yet another embodiment, the first bore and the second bore have a substantially co-linear alignment. In an alternate embodiment, the first bore and the second bore are co-joined at an angle.

In yet another embodiment, the first coupling section and the second coupling section have approximately the same interior and exterior diameters. In an alternate embodiment, the first coupling section and the second coupling section have different interior and exterior diameters.

In another embodiment, the first coupling section further comprises a first channel formed between the first barbed connector and a circumferentially extending rib. The first coupling section may further comprise a second channel formed between the circumferentially extending rib and a second circumferentially extending rib. Moreover, the first coupling section may further comprise a third channel formed between the second circumferentially extending rib and a third circumferentially extending rib.

Similarly, the second coupling section further comprise a fourth channel formed between the second barbed connector and a circumferentially extending rib on the second coupling section. The second coupling section may also comprise a fifth channel formed between the circumferentially extending rib of the second coupling section and a fifth circumferentially extending rib. The second coupling section may also comprise a sixth channel formed between the fifth circumferentially extending rib and a sixth circumferentially extending rib.

In another embodiment, a method of using an insert coupling comprising the steps of: positioning a flexible conduit section onto one of a first or second coupling section the insert coupling; covering at least one channel formed between adjacent ribs of the first or second coupling section with the flexible conduit section; placing a crimping ring over the flexible conduit section and at least one channel of the first or second coupling section; crimping the crimping ring with a tool; and compressing the flexible conduit section into at least one channel of the first or second coupling section.

The method may further comprise the step of:

placing the crimping ring over the flexible conduit section and at least one channel of the first or second coupling section having a seal ring positioned therein.

### BRIEF DESCRIPTION OF THE DRAWINGS

FIG. 1 illustrates a sectional view of cross-linked polyethylene tubing having an aluminum tube as a reinforcing layer;

FIG. 1A illustrates a partial sectional side-view of the insert coupler;

FIG. 2 is a partial sectional side-view of the insert coupler with a flexible conduit and crimping ring attached;

FIG. 3 is a partial sectional side-view of the insert coupler with flexible conduit and crimping ring attached and the crimping ring installed and compressing the conduit within channels;

FIG. 3A is an inset detailed, partial cross-sectional view of the insert coupling shown coupling tri-layered tubing, wherein the insert coupling is positioned subjacent a back panel of a solar collector apparatus;

FIG. 4 is a sectional side-view of the crimping ring, in accordance to one embodiment of the present invention;

FIG. 5 is a side-view of an elbow-shaped insert coupler without a central shoulder;

FIG. 6 is a side-view of an elbow-shaped insert coupler with a central shoulder; and

FIG. 7 is a side-view of the insert coupler having a reducer section.

### DESCRIPTION OF THE EMBODIMENT(S)

It will be readily understood that the components of the present invention, as generally described and illustrated in the figures herein, may be arranged and designed in a wide variety of different configurations.

Thus, the following detailed description of the embodiments as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present invention. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

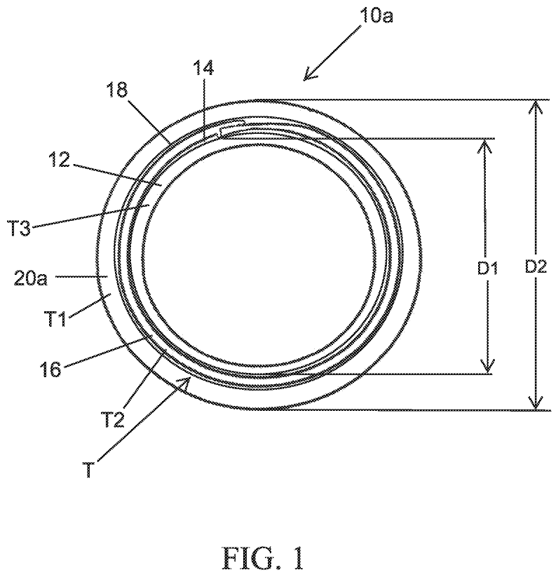

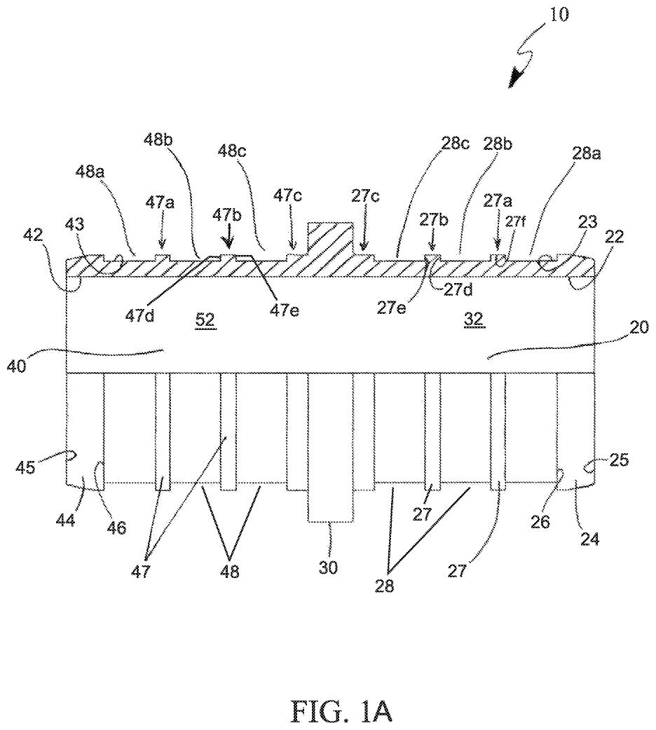

As generally depicted in FIG. 1, pipe, conduit, or tubing may be manufactured from polyethylene (PE) in combination with composite material and carbon black. Ethylene monomer is polymerized to manufacture polyethylene, which is then cross-linked at a selected stage to change the structure from a thermoplastic (moldable) to a thermoset (rigid), thereby increasing high temperature properties, chemical resistance, and permanent physical deformity.

In particular, the cross-linked polyethylene (PEX) composite tubing 10a described herein includes an inner PEX layer 12, an outer polyethylene layer 20a, an intermediate aluminum tube 16, and inner 14 and outer 18 adhesive layers enveloping the intermediate aluminum tube 16.

In one embodiment, consistent with FIG. 1, the combined total thickness (T) of the inner PEX layer 12, the outer polyethylene layer 20a, the intermediate adhesive layers 14, 18, and aluminum tube 16, defining a wall, is envisioned to range from approximately 3.15 mm to 3.60 mm. A minimum thickness value for the outer polyethylene layer 20a thickness (T1) is envisioned to be at least 0.50 mm. A thickness (T2) for the aluminum tube 16 is envisioned to have a value of approximately 0.19 mm±0.02 mm. A value for the inner PEX layer 12 thickness (T3) is envisioned to range between 2.45 mm and 2.75 mm. Overall, the outside diameter (D2) of tubing 10a is envisioned as approximately 24 mm±0.15 mm, with an outside diameter (D1) for the inner PEX layer 12 comprising approximately 22.35 mm±0.15 mm.

The inner 14 and outer 18 adhesive layers may be manufactured from grafted low-density polyethylene (LLDPE). The LLDPE interacts with the PEX-material of the inner layer 12 and the outer layer 20a to form multiple layers of tubing 10. The adhesive layers 14 and 18 are formed to create an envelope surrounding the aluminum tube 16 and to join the inner PEX layer 12 to the inner adhesive layer 14 and join the outer polyethylene layer 20a to the outer adhesive layer 18. It is envisioned that the aluminum tube 16 comprises soft aluminum strips that provides additional mechanical strength to the tubing 10a structure.

It is envisioned that the tubing 10a may be manufactured by the addition of carbon black to the PEX-material used for extruding the inner and outer layers 12 and 20a. In particular, one embodiment includes the production of a PEX-material composition having a pre-defined percentage of fine particles of carbon black material dispersed through the PEX-material product. More particularly, a pre-determined percentage by weight of carbon black material is added to a pre-determined percentage by weight of PEX-material to manufacture a master batch blend for use in the inner layer 12 and/or outer layer 20a of tubing 10a. In one particular embodiment, the carbon black material is added (by a pre-determined percentage by weight) to the PEX-material for manufacture of the outer layer 20a, thereby dispersing the carbon black particles throughout the outer layer 20a and providing a means for dissipating thermal energy through the tubing 10a via the carbon black particles. It is envisioned that the outer layer 20a PEX-material infused with carbon black particles will operate as a screen and also absorb ultraviolet (UV) radiation that is transformed into thermal energy dissipated throughout the tubing 10a.

In one embodiment, the carbon black material comprises approximately 20.0% (by weight) of the outer layer 20a of PEX-material. At approximately 20.0% (by weight), the PEX-material infused with carbon black particles optimizes temperature absorption, including any energy converted from UV or other energy absorbed by the tubing 10a.

In accordance to another embodiment, a pre-determined percentage by weight of carbon black material is added to a pre-determined percentage by weight of PEX-material to manufacture a master batch blend for use in the inner layer 12 of tubing 10a. In one particular embodiment, the carbon black material is added (by a pre-determined percentage by weight) to the PEX-material for manufacture of the inner layer 12, thereby dispersing the carbon black particles throughout the inner layer 12 and providing a means for dissipating thermal energy through the tubing 10a via the carbon black particles.

According to another embodiment, the carbon black material comprises approximately 2.0%±0.50% by weight of the inner layer 12 of PEX-material.

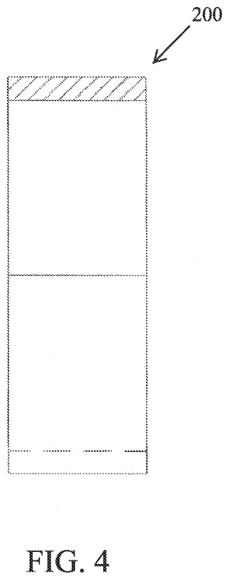

Referring now more particularly to FIGS. 1A-7, an insert coupling 10 article or apparatus adapted and configured to interconnect flexible conduit 100; e.g., composite tubing 101 such as tri-layered tubing 102, as well as interconnect flexible conduit 100 with other conduit, tubing, and piping, is disclosed. An exemplary tri-layered tubing 102 may comprise cross-linked polyethylene composite tubing, as described and illustrated in U.S. Patent Publication No. 2020/0316913 A1, published in the name of Hucks et al.

The insert coupling 10 includes a first coupling section 20 and a second coupling section 40. Each coupling section 20, 40 comprises a tubular wall 21, 41 having an inner surface 22, 42 and an outer surface 23, 43, respectively. The inner surface 22 of first coupling section 20 defines a first bore 32 and the inner surface 42 of second coupling section 40 defines a second bore 52. The first bore 32 and second bore 52 are in mutual fluid communication.

The outer surface 23 of the first coupling section 20 comprises a first barbed connector 24 at the proximal terminus of the tubular wall 21. The first barbed connector 24 comprises an outer circumference 25, an inner circumference 26, and an angled intermediate surface formed by the outer circumference 25 having a smaller circumference than the inner circumference 26. The outer surface 23 of the first coupling section 20 also comprises a plurality of axially-spaced circumferentially extending ribs 27.

A plurality of channels 28 are formed between adjacent ribs 27 along the first coupling section 20. In one embodiment, a first channel 28a is formed between the first barbed connector 24 and a first circumferentially extending rib 27a. A second channel 28b is formed between the first circumferentially extending rib 27a and a second circumferentially extending rib 27b. A third channel 28c is formed between the second circumferentially extending rib 27b and a third circumferentially extending rib 27c.

A first seal ring 29 may be disposed between a pair of adjacent ribs 27. In one embodiment, the first seal ring 29 may be disposed in one of the first, second, or third channels 28a, 28b, or 28c.

It is envisioned that the first coupling section 20 may include at least one channel 28 for receiving a portion of a flexible conduit 100 deformed by compression via a tool or instrument applied to a portion of the flexible conduit 100. As depicted, three channels 28a-28c are included along the first coupling section 20, however, more or less channels 28 may be included as desired and/or as required or necessary.

Similarly to the first coupling section 20, the outer surface 43 of the second coupling section 40 comprises a second barbed connector 44 at the proximal terminus of the tubular wall 41. The second barbed connector 44 comprises an outer circumference 45, an inner circumference 46, and an angled intermediate surface formed by the outer circumference 45 having a smaller circumference than the inner circumference 46. The outer surface 43 of the second coupling section 40 also comprises a plurality of axially-spaced circumferentially extending ribs 47.

A plurality of channels 48 are formed between adjacent ribs 47 along the second coupling section 40. In one embodiment, a fourth channel 48a is formed between the second barbed connector 44 and a fourth circumferentially extending rib 47a. A fifth channel 48b is formed between the fourth circumferentially extending rib 47a and a fifth circumferentially extending rib 47b. A sixth channel 48c is formed between the fifth circumferentially extending rib 47b and a sixth circumferentially extending rib 47c.

A second seal ring 49 may be disposed between a pair of adjacent ribs 47. In one embodiment, the second seal ring 49 may be disposed in one of the fourth, fifth, or sixth channels 48a, 48b, or 48c.

It is envisioned that the second coupling section 40 may include at least one channel 48 for receiving a portion of a flexible conduit 100 deformed by compression via a tool or instrument applied to a portion of the flexible conduit 100. As depicted, three channels 48a-48c are included along the first coupling section 20, however, more or less channels 48 may be included as desired and/or as required or necessary.

The first coupling section 20 and the second coupling section 40 may each have identical quantities of channels 28, 48. It is also envisioned that each section 20, 40 may have different quantities of channels 28, 48 to serve other purposes.

Each one of the channels 28 (48), and as depicted 28a-28c and 48a-48c, are formed from a similar structural arrangement. For example, the first rib 27a and second rib 27b may each comprise a distal circumferential surface 27d and a proximal circumferential surface 27e each downwardly depending from a crown 27f and upwardly depending from the outer surface 23 of tubular wall 21. Likewise, fourth rib 47a and fifth rib 47b may each comprise a distal circumferential surface 47d and a proximal circumferential surface 47e each downwardly depending from a crown 47f and upwardly depending from the outer surface 43 of tubular wall 41. Similarly, third rib 27c (and sixth rib 47c) may each comprise a distal circumferential surface 27d (47d) downwardly depending from a crown 27f (47f). In one embodiment, the shoulder 30 forms the proximal circumferential surface of rib 27c (47c).

Therefore, the first channel 28a (and fourth channel 48a) may be formed from the inner circumference 26 (46) utilized as one upstanding wall depending from the outer surface 23 and the proximal circumferential surface 47e depending from the crown 47f and the outer surface 23.

The second channel 28b may be formed from the proximal circumferential surface 27e of the first rib 27a depending from the crown 27f and the outer surface 23 and the distal circumferential surface 27d of the second rib 27b depending from the crown 27f and the outer surface 23. A similar description applies to fifth channel 48b (with like or similar reference characters and elements).

The third channel 28c may be formed from the proximal circumferential surface 27e of the second rib 27b depending from the crown 27f and the outer surface 23 and the distal circumferential surface 27d of the third rib 27c depending from the crown 27f and the outer surface 23. A similar description applied to the sixth channel 48c (with like or similar reference characters and elements).

Any additional channels 28 (or 48) included along the first coupling section 20 (or second coupling section 40) may be similarly arranged and described. Thus, any additional channel 28 (48) interior to the barbed connector 24 (44) and exterior to the center (such as a shoulder 30) may be described as formed from the proximal circumferential surface 27e (47e) of a rib 27 (47) and the distal circumferential surface 27d (47d) of an adjacent rib 27 (47) and the outer surface 23 (43) bounding the channel 28 (48) as the floor.

The insert coupling 10 may comprise a circumferentially extending shoulder 30 intermediately disposed between the first coupling section 20 and the second coupling section 40. The first bore 32 and second bore 52 are in mutual fluid communication through the center of the shoulder.

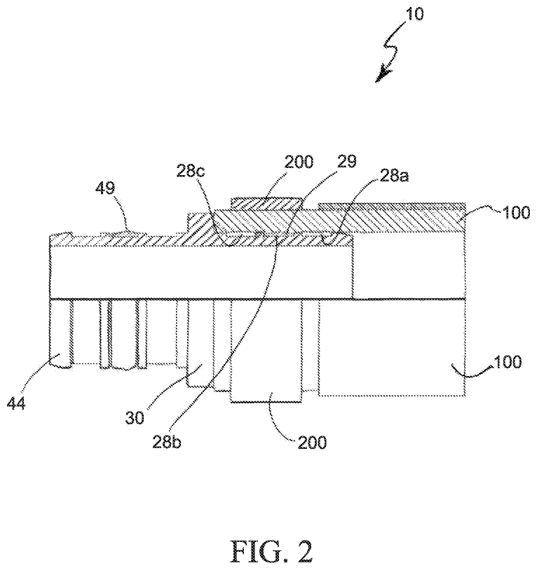

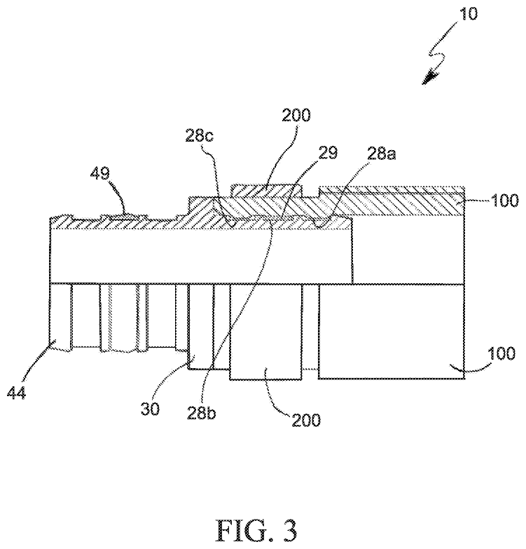

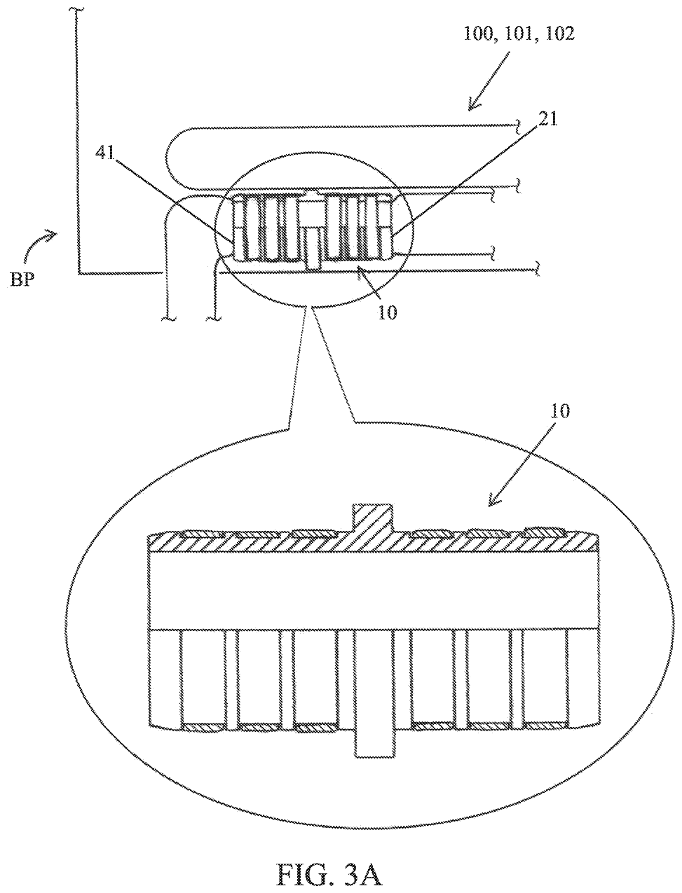

As generally depicted in FIGS. 2 and 3, a flexible conduit 100 or pipe (e.g., cross-linked polyethylene (PEX)or a cross-linked polyethylene composite) is slidingly urged over the first coupling section 20 so that a portion of the conduit/pipe 100 is superjacent the ribs 27 and channels 28 provided on the first coupling section 20. A crimping ring 200 (consistent with the ring 200 depicted in FIGS. 2, 3, and 4) is arranged to encircle a portion of the outer circumference of the conduit/pipe 100 approximately equal to the width of the crimping ring 200. The crimping ring 200 has a width sufficient to traverse the width of at least one channel 28. It is envisioned that the crimping ring 200 has a width sufficient to traverse the width of at least one channel 28b and at least portions of the additional channels 28a and/or 28c as depicted. In this manner, the crimping ring 200 allows for the conduit/pipe 100 to be compressible along more surface area of the ribs 27 and channels 28 provided. In FIG. 3A, the insert coupling 10 depicted coupling tri-layered tubing 102, the insert coupling 10 shown positioned subjacent a back panel BP of a solar collector apparatus, such as the apparatus described and depicted in U.S. Pat. No. 9,797,626 B1.

In operation, a tool (such as a crimping tool, pliers, channel-locks, or other similar tool or instrument) is used to compress the circumference of the crimping ring 200 against the flexible conduit/pipe 100, thereby compressing the inner circumference of the conduit/pipe 100 against the ribs 27 and into the channels 28 provided, forming a seal to prevent fluid leakage (as depicted in FIG. 2). Moreover, with the inclusion of a seal ring 29 in one of the channels (28b as depicted), an additional sealing barrier is provided within the inner circumference of the conduit/pipe 100.

It is envisioned that the same or similar description, labels, and reference characters (consistent with the sections 20, 40) may be used to describe the arrangement of the conduit/pipe 100 slidingly positioned on the second coupling section 40 with its respective ribs 47, channels 48, and seal ring 49, and compression of the conduit/pipe 100 via a second crimping ring (not shown).

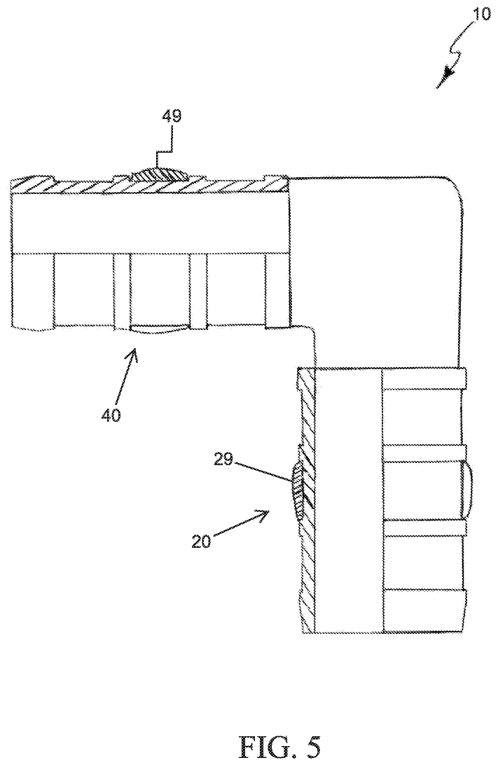

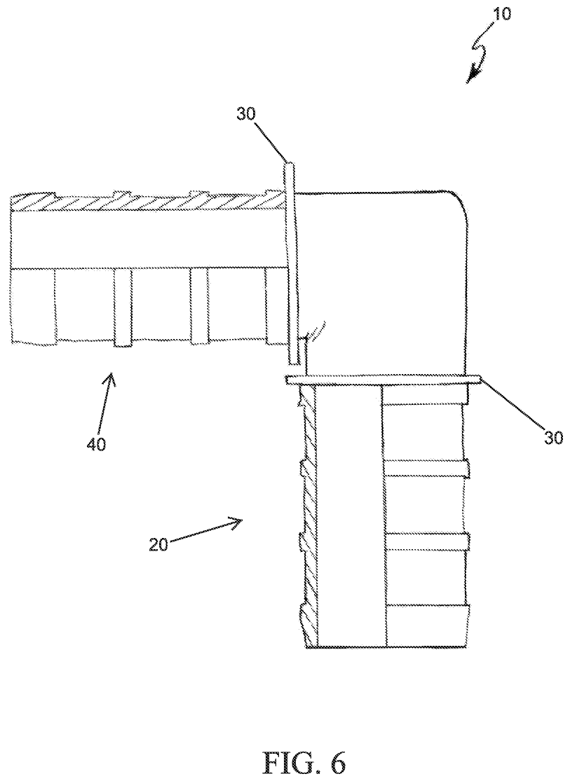

It is envisioned that the first coupling section 20 and the second coupling section 40 may comprise a variety of relative configurations. For example, as depicted in FIGS. 1 through 4, the first coupling section 20 and second coupling section 40 are mutually co-extensive and are united as a continuous unit so that first bore 32 and second bore 52 form a single, unitary bore through the insert coupling 10. In another embodiment, as depicted in FIG. 5, the first coupling section 20 and the second coupling section 40 are arranged at one of a variety of angles relative to the other. As depicted in FIGS. 5 and 6, the first coupling section 20 and the second coupling section 40 are arranged at approximately 90 degrees to form an elbow joint via the insert coupling 10. Other angles are contemplated, including acute and obtuse angles relative between the first coupling section 20 and the second coupling section 40. In these embodiments, the shoulder 30 may be omitted (as depicted in FIG. 5) or may be included approximately central within the insert coupling 10 (as depicted in FIG. 6), so that each coupling section 20, 40 includes a separate shoulder 30.

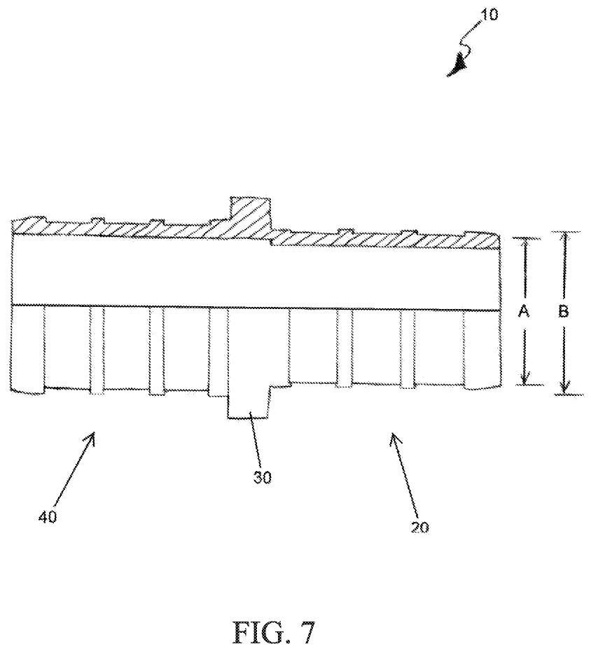

As depicted in FIG. 7, it is also envisioned that the first coupling section 20 and the second coupling section 40 may comprise different diameters, thereby functioning as a reducer insert coupling if necessary or desired. As depicted in FIG. 7, the diameter of the first coupling section 20 (A) is lesser than the diameter of the second coupling section 40 (B). The dimensions of the ribs 27 (47) and/or channels 28 (48) may be the same or similar. It is envisioned that the dimensions of the ribs 27 (47) and/or channels 28 (48) may be reduced on the smaller diameter section 20, 40.

Although a variety of materials may be used to construct the insert coupling 10, it is envisioned that brass or another durable material is optimal. It is envisioned that rigid engineering thermoplastic (e.g., polyphenylsulfone (PPSU) and/or polyvinylidene fluoride (PVDF) may be used in certain conditions as suitable.

It is to be understood that the embodiments and claims are not limited in application to the details of construction and arrangement of the components set forth in the description and/or illustrated in drawings. Rather, the description and/or the drawings provide examples of the embodiments envisioned, but the claims are not limited to any particular embodiment or a preferred embodiment disclosed and/or identified in the specification. Any drawing figures that may be provided are for illustrative purposes only, and merely provide practical examples of the invention disclosed herein. Therefore, any drawing figures provided should not be viewed as restricting the scope of the claims to what is depicted.

The embodiments and claims disclosed herein are further capable of other embodiments and of being practiced and carried out in various ways, including various combinations and sub-combinations of the features described above but that may not have been explicitly disclosed in specific combinations and sub-combinations.

Accordingly, those skilled in the art will appreciate that the conception upon which the embodiments and claims are based may be readily utilized as a basis for the design of other structures, methods, and systems. In addition, it is to be understood that the phraseology and terminology employed herein are for the purposes of description and should not be regarded as limiting the claims.

What is claimed is:

1. In insert coupling comprising:
a first coupling section comprising a tubular wall having an inner surface and an outer surface;
the inner surface having a first bore;
the outer surface having a first barbed connector at the proximal terminus of the tubular wall, a plurality of axially-spaced circumferentially extending ribs, and a first seal ring disposed between an adjacent pair of the plurality of ribs; and
a second coupling section comprising a tubular wall having an inner surface and an outer surface;
the inner surface having a second bore;
the outer surface having a second barbed connector at the proximal terminus of the tubular wall, a plurality of axially-spaced circumferentially extending ribs, and a second seal ring disposed between an adjacent pair of the plurality of ribs; wherein the first bore and the second bore are in mutual fluid communication.

2. An insert coupling comprising:
a first coupling section comprising a tubular wall haying an inner surface and an outer surface;
the inner surface having a first bore;
the outer surface having a first barbed connector at the proximal terminus of the tubular wall, a plurality of axially-spaced circumferentially extending ribs, and a plurality of channels formed between the plurality of ribs; and
a first seal ring disposed in one of the plurality of channels;
a second coupling section comprising a tubular wall having an inner surface and an outer surface;
the inner surface having a second bore;
the outer surface having a second barbed connector at the proximal terminus of the tubular wall, a plurality of axially-spaced circumferentially extending ribs, and a plurality of channels formed between the plurality of ribs;
a second seal ring disposed one of the plurality of channels; and
a circumferentially extending first shoulder surface and a circumferentially extending second shoulder surface, the first shoulder surface adjacent the first coupling section and the second should surface adjacent the second coupling section.

3. The insert coupling of claim 2, wherein the first shoulder surface and the second shoulder surface form a single circumferential shoulder intermediately disposed between first coupling section and the second coupling section.

4. The insert coupling of claim 2, wherein the first shoulder surface defines a distal shoulder surface of a first shoulder circumferentially extending adjacent the first coupling section.

5. The insert coupling of claim 2, wherein the second should surface defines a distal shoulder surface of a second shoulder circumferentially extending adjacent the second coupling section.

6. The insert coupling of claim 2, wherein the first bore and the second bore have a substantially co-linear alignment.

7. The insert coupling of claim 2, wherein the first bore and the second bore are co-joined at an angle.

8. The insert coupling of claim 2, wherein the first coupling section and the second coupling section have approximately the same interior and exterior diameters.

9. The insert coupling of claim 2, wherein the first coupling section and the second coupling section have different interior and exterior diameters.

10. The insert coupling of claim 2, wherein the first coupling section further comprises:
a first channel formed between the first barbed connector and a circumferentially extending rib.

11. The insert coupling of claim 10, wherein the first coupling section further comprises:
a second channel formed between the circumferentially extending rib and second circumferentially extending rib.

12. The insert coupling of claim 11, wherein the first coupling section further comprises:
a third channel formed between the second circumferentially extending rib and third circumferentially extending rib.

13. The insert coupling of claim 2, wherein the second coupling section further comprises:
a fourth channel formed between the second barbed connector and a circumferentially extending rib on the second coupling section.

14. The insert coupling of claim 13, wherein the second coupling section further comprises:
a fifth channel formed between the circumferentially extending rib of the second coupling section and a fifth circumferentially extending rib.

15. The insert coupling of claim 14, wherein the second coupling section further comprises:
a sixth channel formed between the fifth circumferentially extending rib and a sixth circumferentially extending rib.

16. A method of using an insert coupling comprising the steps of:
positioning a flexible conduit section onto one of a first or second coupling section of the insert coupling;
covering at least one channel formed between adjacent ribs of the first or second coupling section with the flexible conduit section;
placing a crimping ring over the flexible conduit section and at least one channel of the first or second coupling section;
crimping the crimping ring with a tool; and
compressing the flexible conduit section into at least one channel of the first or second coupling section.

17. The method of claim 16 further comprising the step of: placing the crimping ring over the flexible conduit section and at least one channel of the first or second coupling section having a seal ring positioned therein.
